(19) United States
(12) Patent Application Publication
(10) Pub. No.: US 2011/0314949 A1
(43) Pub. Date: Dec. 29, 2011

(54) ROBOT

(75) Inventor: BO LONG, Shenzhen City (CN)

(73) Assignees: HON HAI PRECISION INDUSTRY CO., LTD., New Taipei (TW); HONG FU JIN PRECISION INDUSTRY (ShenZhen) CO., LTD., Shenzhen City (CN)

(21) Appl. No.: 13/005,612

(22) Filed: Jan. 13, 2011

(30) Foreign Application Priority Data
Jun. 29, 2010 (CN) 201010211767.0

(51) Int. Cl. B25J 18/04

(52) U.S. Cl. 74/490.04

(57) ABSTRACT

A robot includes a first rotation member, a second rotation member, a driver, a cable assembly, a transmission assembly, and a guide member. The second rotation member is rotatably connected to the first rotation member, and capable of rotating about a rotation axis. The driver is configured to drive the second rotation member. The cable assembly includes a plurality of cables with at least one cable connecting to the driver. The transmission assembly is configured to transmit rotation from the driver to the second rotation member. The guide member is fixed to the first rotation member, and defines a guide hole extending along the rotation axis, through which the cable assembly passes. The second rotation member and the driver are disposed at distances deviating from the rotation axis.

### BACKGROUND

1. Technical Field

The present disclosure generally relates to a robot.

2. Description of Related Art

As developments in manufacturing technology progress, robots are increasingly applied to perform functions in environments considered hazardous or difficult for operators.

Cables are provided to transmit electric signals or to control signals for the specific elements of the robot; and in order to maintain an orderly appearance, the cables are housed inside the robot and passed through a plurality of arms of the robot. When running from one arm to another, the cables pass through a plurality of holes in the arms. However, action of the arms may abrade or even sever the cables adjacent to the joint.

Therefore, there is room for improvement within the art.

### BRIEF DESCRIPTION OF THE DRAWINGS

The components in the drawings are not necessarily drawn to scale, the emphasis being placed upon clearly illustrating the principles of the present disclosure. Moreover, in the drawings, like reference numerals designate corresponding parts throughout several views, and all the views are schematic.

FIG. 1 is a top assembled view of one embodiment of a robot.

FIG. 2 is similar to FIG. 1, but viewed from another aspect.

FIG. 3 is a cross-section of the robot of FIG. 1 taken along a line labeled as III-III.

### DETAILED DESCRIPTION

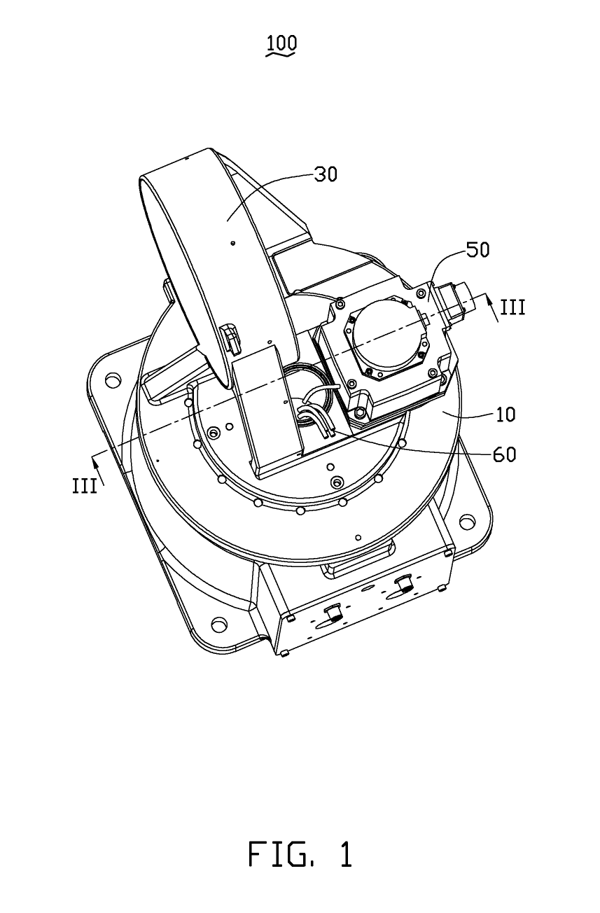

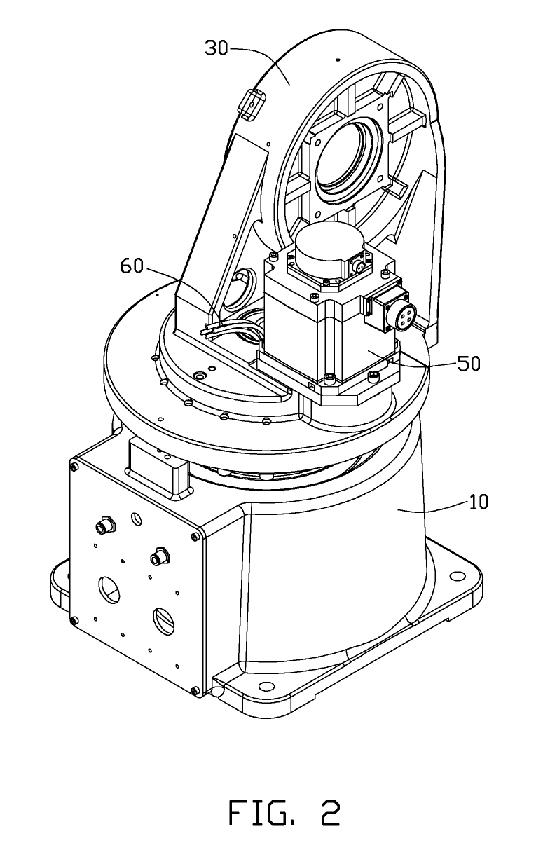

Referring to FIG. 1 and FIG. 2, a robot 100 includes a first rotation member 10, a second rotation member 30, a driver 50 and a cable assembly 60. The second rotation member 30 is rotatably connected to the first rotation member 10, and the driver 50 can rotate the second rotation member 30 relative to the first rotation member 10.

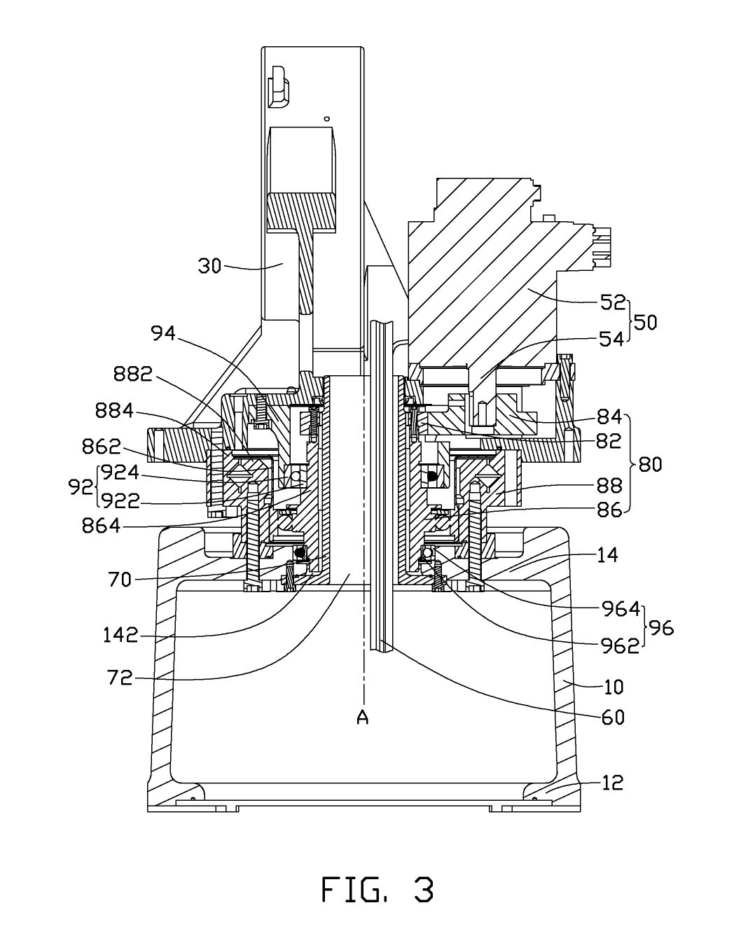

Also referring to FIG. 3, the robot 100 further includes a guide member 70 and a transmission assembly 80. The first rotation member 10 is substantially a hollow column, and includes a first fixing end 12 and a second fixing end 14 opposite to the first fixing end 12. The first fixing end 12 is configured to fix the robot 100 to a fixed object, such as ground. The second fixing end 14 defines a through hole 142 through which the cable assembly 60 passes. The through hole 142 is collinear with a rotation axis A around which the second rotation member 30 rotates.

The guide member 70 is substantially a cylinder. The guide member 70 substantially extends parallel to the rotation axis A with one end of the guide member 70 securely received in the through hole 142 of the second fixing end 14. The guide member 70 defines a guide hole 72 through the end of the guide member 70 which is received in the through hole 142 and an end of the guide member 70 opposite, and communicating with an interior space of the first rotation member 10. A centerline of the guide hole 72 is collinear with or parallel to the rotation axis A. In the illustrated embodiment, the robot is a six-axis robot, and the cable assembly 60 includes a plurality of cables with at least one cable connecting to the driver 50. The cable assembly 60 passes through the guide hole 72.

The transmission assembly 80 includes a central gear 82, an input gear 84, a deceleration member 86, and a first bearing 88. The central gear 82 is rotatably sleeved on the guide member 70, and is rotatable relative to the rotation axis A. The input gear 84 meshes with the central gear 82. In the illustrated embodiment, the deceleration member 86 is a harmonic drive (HD) retarder, and includes a rigid gear 862 and a flexible gear 864 meshed with the rigid gear 862. The flexible gear 864 is sleeved on the guide member 70, and fixed to the central gear 82 by a plurality of fasteners (not shown).

The first bearing 88 is a crossed roller bearing, and includes an inner ring 882 and an outer ring 884. The inner ring 882 is fixed to the second fixing end 14 by a plurality of fasteners (not labeled). The first bearing 88 is sleeved on the guide member 70 with the outer ring 884 fixed to the rigid gear 862 of the deceleration member 86, such that the outer ring 884 is capable of rotating with the rigid gear 862. The second rotation member 30 is fixed to the outer ring 884 of the first bearing 88 by a plurality of fasteners (not labeled).

The driver 50 is a motor, and includes a main body 52 and an output shaft 54. The main body 52 is fixed to the second rotation member 30, and corresponds to the input gear 84, such that the second rotation member 30 and the driver 50 are disposed at a plurality of distances deviating from the rotation axis A. The input gear 84 is sleeved on the output shaft 54 to rotate with the output shaft 54.

The robot 100 further includes a second bearing 92 and a bracket 94. The second bearing 92 includes an inner ring 922 and an outer ring 924. The inner ring 922 is securely sleeved on a middle portion of the flexible gear 864 of the deceleration member 86. An end of the bracket 94 is fixed to an end of the second rotation member 30 adjacent to the first rotation member 10, and an opposite end of the bracket 94 is fixed to the outer ring 924 of the second bearing 92 to support the second bearing 92.

The robot 100 further includes a third bearing 96 including an inner ring 962 and an outer ring 964. The inner ring 962 is securely sleeved on an end of the flexible gear 864 of the deceleration member 86 adjacent to the second fixing end 14 of the first rotation member 10 to support the flexible gear 864. The outer ring 964 is fixed to the second fixing end 14 of the first rotation member 10.

When the robot 100 is powered, the output shaft 54 of the driver 50 rotates. The input gear 84 connected to the output shaft 54 rotates therewith, and the central gear 82, meshes with and rotates the input gear 84. The outer ring 884 of the first bearing 88 rotates with the input gear 84, and finally the second rotation member 30 rotates around the guide member 70 with the outer ring 884.

Since the guide member 70 defines a guide hole 72 extending along the rotation axis A, and through which the cable assembly 60 passes, when the second rotation member 30 rotates relative to the first rotation member 10 around the rotation axis A, the cable assembly 60 is received in the guide member 70 around which the second rotation member 30 rotates, such that the cable assembly 60 will not wind around the second rotation member 30, whereby damage thereto is avoided, the lifespan of the cable assembly 60 is extended, and the stability of the robot 100 is enhanced.

The second rotation member 30 and the driver 50 are disposed at distances deviating from the rotation axis A along which the guide member 70 extends, and the second rotation member 30 is connected to the driver 50 via the transmission assembly 80, the second rotation member 30 and the driver 50 thus avoid being disposed along the rotation axis A, such that the robot 100 can achieve a more compact size.

Alternatively, the second bearing 92, the bracket 94, and the third bearing 96 can be omitted, as long as the flexible gear 864 of the deceleration member 86 is connected to the central gear 82 directly. The deceleration member 86 is not limited to a harmonic drive retarder, but can be alternatively, a rotational vector (RV) retarder. The deceleration member 86 may be omitted when the rotational speed of the output shaft 54 of the driver 50 is sufficiently low.

The deceleration member 86 may be connected to the output shaft 54 of the driver 50 by a belt transmission, rather than by using the central gear 82 and the input gear 84. The driver 50 is not limited to be fixed to the second rotation member 30, but can be alternatively, fixed to the first rotation member 10.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A robot, comprising:
a first rotation member;
a second rotation member rotatably connected to the first rotation member, and the second rotation member being rotatable relative to a rotation axis;
a driver for driving the second rotation member;
a cable assembly comprising a plurality of cables with at least one cable connected to the driver;
a transmission assembly transmitting rotation from the driver to the second rotation member; and
a guide member fixed to the first rotation member, wherein the guide member defines a guide hole extending along the rotation axis through which the cable assembly passes, and the second rotation member and the driver are disposed at a plurality of distances deviating from the rotation axis.

2. The robot of claim 1, wherein the transmission assembly comprises a central gear, an input gear meshed with the central gear, and a deceleration member, the central gear is rotatably sleeved on the guide member, the input gear is driven by the driver, and the second rotation member is connected to the central gear via the deceleration member.

3. The robot of claim 2, wherein the deceleration member is a harmonic drive retarder, and comprises a rigid gear and a flexible gear meshed with the rigid gear, the flexible gear is sleeved on the guide member and fixed to the central gear, and the second rotation member is connected to the rigid gear.

4. The robot of claim 3, wherein the transmission assembly further comprises a first bearing, the first bearing comprises an inner ring sleeved on the guide member, and an outer ring fixed to the rigid gear, the inner ring is fixed to the first rotation member, and the second rotation member is fixed to the outer ring.

5. The robot of claim 4, wherein the first bearing is a crossed roller bearing.

6. The robot of claim 4, further comprising a second bearing and a bracket, wherein the second bearing comprises an inner ring securely sleeved on the flexible gear of the deceleration member, and an outer ring, an end of the bracket is fixed to an end of the second rotation member adjacent to the first rotation member, and an opposite end of the bracket is fixed to the outer ring of the second bearing to support the second bearing.

7. The robot of claim 4, further comprising a third bearing, wherein the third bearing comprises an inner ring securely sleeved on the flexible gear of the deceleration member, and an outer ring fixed to the first rotation member.

8. The robot of claim 1, wherein the driver is fixed to the second rotation member.

9. The robot of claim 1, wherein the first rotation member comprises a first fixing end and a second fixing end opposite to the first fixing end, and the second fixing end defines a through hole for the cable assembly.

10. The robot of claim 9, wherein an end of the guide member is securely received in the through hole.

11. The robot of claim 2, wherein the driver is a motor comprising a main body and an output shaft, and the input gear is sleeved on the output shaft to rotate with the output shaft.
